(19) United States
(12) Patent Application Publication
(10) Pub. No.: US 2025/0212146 A1
(43) Pub. Date: Jun. 26, 2025

(54) TERMINAL, RADIO COMMUNICATION METHOD, AND BASE STATION

(71) Applicant: NTT DOCOMO, INC., Tokyo (JP)

(72) Inventors: Yuki Matsumura, Chiyoda-ku, Tokyo (JP); Satoshi Nagata, Chiyoda-ku, Tokyo (JP); Weiqi Sun, Haidian District, Beijing (CN); Jing Wang, Haidian District, Beijing (CN); Lan Chen, Haidian District, Beijing (CN)

(73) Assignee: NTT DOCOMO, INC., Tokyo (JP)

(21) Appl. No.: 18/848,356

(22) PCT Filed: Mar. 31, 2022
(86) PCT No.: PCT/JP2022/016881

§ 371 Date: Sep. 18, 2024

(51) Int. Cl. H04W 56/00; H04L 5/00; H04W 72/21; H04W 72/232

(52) U.S. Cl. CPC H04W 56/0045; H04L 5/0053; H04W 72/21; H04W 72/232

(57) ABSTRACT

A terminal according to one aspect of the present disclosure includes a control section that judges, based on a specific index, a timing advance to be applied to certain uplink transmission, from among a plurality of timing advances, and a transmitting section that performs the uplink transmission, based on the timing advance. According to one aspect of the present disclosure, it is possible to appropriately control UL transmission using more than four antenna ports.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+ (plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

In future radio communication systems (for example, radio communication systems later than Rel. 16/5G), it is assumed that communication is controlled based on inter-cell mobility including a non-serving cell or inter-cell mobility using a plurality of transmission/reception points (for example, multi-TRP (MTRP)).

However, when UL transmission to the plurality of transmission/reception points is performed, how to perform control of the UL transmission (for example, control of a timing advance and the like) is an issue. Unless UL transmission to each transmission/reception point is appropriately controlled, quality of communication using the plurality of transmission/reception points may deteriorate.

Thus, an object of the present disclosure is to provide a terminal, a radio communication method, and a base station that can appropriately control UL transmission to a plurality of TRPs.

### Solution to Problem

A terminal according to one aspect of the present disclosure includes a control section that judges, based on a specific index, a timing advance to be applied to certain uplink transmission, from among a plurality of timing advances, and a transmitting section that performs the uplink transmission, based on the timing advance.

### Advantageous Effects of Invention

According to one aspect of the present disclosure, it is possible to appropriately control UL transmission to a plurality of TRPs.

### BRIEF DESCRIPTION OF DRAWINGS

FIGS. 1A to 1D are diagrams to show examples of a multi-TRP scenario.

FIG. 2 is a diagram to show an example of a timing advance group (TAG) to which a cell included in a cell group belongs.

FIGS. 3A and 3B are diagrams to show examples of postponement based on a TA gap in M-TRP PUSCH/PUCCH repetition.

FIG. 4 is a diagram to show an example of application of TAs to multi-panel simultaneous PUSCH/PUCCH transmission.

FIG. 5 is a diagram to show an example of a schematic structure of a radio communication system according to one embodiment.

FIG. 6 is a diagram to show an example of a structure of a base station according to one embodiment.

FIG. 7 is a diagram to show an example of a structure of a user terminal according to one embodiment.

FIG. 8 is a diagram to show an example of a hardware structure of the base station and the user terminal according to one embodiment.

FIG. 9 is a diagram to show an example of a vehicle according to one embodiment.

### DESCRIPTION OF EMBODIMENTS

### TCI, Spatial Relation, QCL

For NR, it is studied that reception processing (for example, at least one of reception, demapping, demodulation, and decoding) and transmission processing (for example, at least one of transmission, mapping, precoding, modulation, and coding) of at least one of a signal and a channel (expressed as a signal/channel) in a terminal (user terminal, User Equipment (UE)) are controlled based on a transmission configuration indication state (TCI state).

The TCI state may be a state applied to a downlink signal/channel. A state that corresponds to the TCI state applied to an uplink signal/channel may be expressed as spatial relation.

The TCI state is information related to quasi-co-location (QCL) of the signal/channel, and may be referred to as a spatial reception parameter, spatial relation information, or the like. The TCI state may be configured for the UE for each channel or for each signal.

QCL is an indicator indicating statistical properties of the signal/channel. For example, when a certain signal/channel and another signal/channel are in a relationship of QCL, it may be indicated that it is assumable that at least one of Doppler shift, a Doppler spread, an average delay, a delay spread, and a spatial parameter (for example, a spatial reception parameter (spatial Rx parameter)) is the same (the relationship of QCL is satisfied in at least one of these) between such a plurality of different signals/channels.

Note that the spatial reception parameter may correspond to a receive beam of the UE (for example, a receive analog beam), and the beam may be identified based on spatial QCL. The QCL (or at least one element in the relationship of QCL) in the present disclosure may be used interchangeably with sQCL (spatial QCL).

For the QCL, a plurality of types (QCL types) may be defined. For example, four QCL types A to D may be provided, which have different parameter(s) (or parameter set(s)) that can be assumed to be the same, and such parameter(s) (which may be referred to as QCL parameter(s)) are described below:
QCL type A (QCL-A): Doppler shift, Doppler spread, average delay, and delay spread
QCL type B (QCL-B): Doppler shift and Doppler spread
QCL type C (QCL-C): Doppler shift and average delay
QCL type D (QCL-D): Spatial reception parameter

A case that the UE assumes that a certain control resource set (CORESET), channel, or reference signal is in a relationship of specific QCL (for example, QCL type D) with another CORESET, channel, or reference signal may be referred to as QCL assumption.

The UE may determine at least one of a transmit beam (Tx beam) and a receive beam (Rx beam) of the signal/channel, based on the TCI state or the QCL assumption of the signal/channel.

The TCI state may be, for example, information related to QCL between a channel as a target (in other words, a reference signal (RS) for the channel) and another signal (for example, another RS). The TCI state may be configured (indicated) by higher layer signaling or physical layer signaling, or a combination of these.

In the present disclosure, the higher layer signaling may be, for example, any one or combinations of Radio Resource Control (RRC) signaling, Medium Access Control (MAC) signaling, broadcast information, and the like.

The MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

The physical layer signaling may be, for example, downlink control information (DCI).

Note that a channel/signal being a target of application of a TCI state may be referred to as a target channel/reference signal (RS) or simply as a target, and another signal described above may be referred to as a reference reference signal (reference RS), a source RS, or simply as a reference.

A channel for which the TCI state or spatial relation is configured (specified) may be, for example, at least one of a downlink shared channel (Physical Downlink Shared Channel (PDSCH)), a downlink control channel (Physical Downlink Control Channel (PDCCH)), an uplink shared channel (Physical Uplink Shared Channel (PUSCH)), and an uplink control channel (Physical Uplink Control Channel (PUCCH)).

The RS to have a QCL relationship with the channel may be, for example, at least one of a synchronization signal block (SSB), a channel state information reference signal (CSI-RS), a reference signal for measurement (Sounding Reference Signal (SRS)), a CSI-RS for tracking (also referred to as a Tracking Reference Signal (TRS)), a reference signal for QCL detection (also referred to as a QRS), a demodulation reference signal (DMRS), and the like.

The SSB is a signal block including at least one of a primary synchronization signal (PSS), a secondary synchronization signal (SSS), and a broadcast channel (Physical Broadcast Channel (PBCH)). The SSB may be referred to as an SS/PBCH block.

An RS of QCL type X in a TCI state may mean an RS in a relationship of QCL type X with (a DMRS of) a certain channel/signal, and this RS may be referred to as a QCL source of QCL type X in the TCI state.

### Multi-TRP

For NR, it is studied that one or a plurality of transmission/reception points (TRPs) (multi-TRP (M-TRP)) perform DL transmission to a UE by using one or a plurality of panels (multi-panel). It is also studied that the UE performs UL transmission to the one or plurality of TRPs.

Note that the plurality of TRPs may correspond to the same cell identifier (ID), or may correspond to different cell IDs. The cell ID may be a physical cell ID (for example, a PCI) or a virtual cell ID.

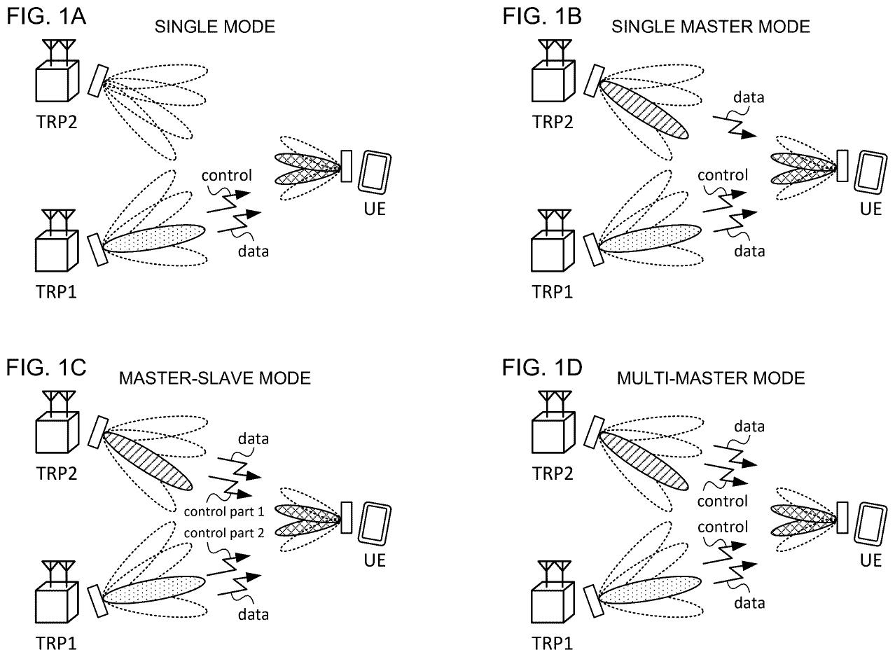

FIGS. 1A to 1D are diagrams to show examples of a multi-TRP scenario. In these examples, it is assumed that each TRP can transmit four different beams, but this is not restrictive.

FIG. 1A shows an example of a case where only one TRP (in the present example, TRP 1) of the multi-TRP performs transmission to the UE (which may be referred to as a single mode, a single TRP, or the like). In this case, TRP 1 transmits, to the UE, both a control signal (PDCCH) and a data signal (PDSCH).

FIG. 1B shows an example of a case where only one TRP (in the present example, TRP 1) of the multi-TRP transmits a control signal to the UE and where the multi-TRP transmits data signals (which may be referred to as a single master mode). The UE receives respective PDSCHs transmitted from the multi-TRP, based on one piece of downlink control information (DCI).

FIG. 1C shows an example of a case where each of the multi-TRP transmits part of a control signal to the UE and where the multi-TRP transmits data signals (which may be referred to as a master slave mode). Part 1 of the control signal (DCI) may be transmitted in TRP 1, and part 2 of the control signal (DCI) may be transmitted in TRP 2. Part 2 of the control signal may depend on part 1. The UE receives, based on these parts of the DCI, respective PDSCHs transmitted from the multi-TRP.

FIG. 1D shows an example of a case where each of the multi-TRP transmits a separate control signal to the UE and where the multi-TRP transmits data signals (which may be referred to as a multi-master mode). A first control signal (DCI) may be transmitted in TRP 1, and a second control signal (DCI) may be transmitted in TRP 2. The UE receives, based on the DCIs, respective PDSCHs transmitted from the multi-TRP.

When such plurality of PDSCHs (which may be referred to as multi-PDSCH (multiple PDSCHs)) from the multi-TRP as that shown in FIG. 1B are scheduled by using one piece of DCI, the DCI may be referred to as single DCI (S-DCI, single PDCCH). When such plurality of PDSCHs from the multi-TRP as that shown in FIG. 1D are scheduled by using multiple DCIs respectively, the multiple DCIs may be referred to as multi-DCI (M-DCI, multi-PDCCH (multiple PDCCHs)).

From each TRP of the multi-TRP, a different transport block (TB)/codeword (Code word (CW))/different layer may be transmitted. Alternatively, from each TRP of the multi-TRP, the same TB/CW/layer may be transmitted.

As one form of the multi-TRP transmission, non-coherent joint transmission (NCJT) is under study. In NCJT, for example, TRP 1 performs modulation mapping on a first codeword, performs layer mapping, and transmits a first PDSCH in a first number of layers (for example, two layers) by using first precoding. TRP 2 performs modulation mapping on a second codeword, performs layer mapping, and transmits a second PDSCH in a second number of layers (for example, two layers) by using second precoding.

Note that a plurality of PDSCHs (multi-PDSCH) transmitted by NCJT may be defined to partially or entirely overlap in terms of at least one of the time and frequency domains. In other words, the first PDSCH from a first TRP and the second PDSCH from a second TRP may overlap in terms of at least one of the time and frequency resources.

The first PDSCH and the second PDSCH may be assumed not to be in a quasi-co-location (QCL) relationship (not to be quasi-co-located). Reception of the multi-PDSCH may be used interchangeably with simultaneous reception of PDSCHs of a QCL type other than a certain QCL type (for example, QCL type D).

For URLLC for multi-TRP, it is studied that PDSCH (transport block (TB) or codeword (CW)) repetition over multi-TRP is supported. It is studied that schemes for repetition over multi-TRP on a frequency domain, a layer (space) domain, or a time domain (URLLC schemes, for example, schemes 1, 2a, 2b, 3, and 4) are supported. In scheme 1, multi-PDSCH from the multi-TRP is space division multiplexed (SDMed). In schemes 2a and 2b, PDSCHs from the multi-TRP are frequency division multiplexed (FDMed). In scheme 2a, a redundancy version (RV) is the same for the multi-TRP. In scheme 2b, an RV may be the same or may be different for the multi-TRP. In schemes 3 and 4, multi-PDSCH from the multi-TRP is time division multiplexed (TDMed). In scheme 3, multi-PDSCH from the multi-TRP is transmitted in one slot. In scheme 4, multi-PDSCH from the multi-TRP is transmitted in different slots.

According to such a multi-TRP scenario, more flexible transmission control using a high quality channel is available.

There is a possibility that NCJT using multi-TRP/multi-panel uses a high rank. For supporting ideal and non-ideal backhaul between a plurality of TRPs, both single DCI (single PDCCH, for example, FIG. 1B) and multi-DCI (multi-PDCCH, for example, FIG. 1D) may be supported. For both of the single DCI and the multi-DCI, a maximum number of TRPs may be 2.

For single PDCCH design (for ideal backhaul, mainly), TCI enhancement is under study. Each TCI codepoint in DCI may correspond to one or two TCI states. A TCI field size may be the same as that of Rel. 15.

With respect to a PDCCH/CORESET defined in Rel. 15, one TCI state without a CORESET pool index (CORESETPoolIndex) (which may be referred to as TRP information (TRP Info)) is configured for one CORESET.

With respect to enhancement of a PDCCH/CORESET defined in Rel. 16, a CORESET pool index is configured for each CORESET in multi-DCI-based multi-TRP.

Incidentally, for future radio systems (for example, Rel-17 (or later versions) NR), it is studied that a plurality of (for example, two) SRS resource indicators (SRIs)/transmitted precoding matrix indicators (TPMIs) are indicated by using single piece of DCI (S-DCI) for performing PUSCH repetition transmission with multiple TRPs (MTRP PUSCH repetition).

For example, in a case of codebook-based transmission, the UE may determine a precoder for PUSCH transmission, based on an SRI, a transmitted rank indicator (TRI), and a TPMI. In a case of non-codebook-based transmission, the UE may determine a precoder for PUSCH transmission, based on an SRI. Note that the SRI may be specified for the UE by DCI, or may be given by a higher layer parameter.

When the single piece of DCI indicates a plurality of SRIs/TPMIs, Option 1 or Option 2 below is conceivable;
Option 1: an SRI/TPMI (value) for a plurality of (for example, two) TRPs is indicated by using a field for indicating a plurality of (for example, two) SRIs/TPMIs; and
Option 2: a field for indicating one SRI/TPMI is indicated, and the field for indicating the SRI/TPMI is configured with a codepoint corresponding to values of a plurality of (for example, two) SRIs/TPMIs.

In option 1, a codepoint of each of a plurality of SRI/TPMI fields may correspond to one TPMI value. Correspondence (association) between SRI/TPMI fields and SRI/TPMI values may be predefined by a specification. The correspondence (association) between SRI/TPMI fields and SRI/TPMI values may use correspondence defined in Rel. 16 (or earlier versions), or may be correspondence defined in Rel. 17 (or later versions). The correspondence between SRI/TPMI fields and SRI/TPMI values may vary for each plurality of SRI/TPMI fields.

In option 2, a codepoint with one indicated SRI/TPMI field may correspond to a plurality of (for example, two) SRI/TPMI values. Correspondence (association) between SRI/TPMI fields and SRI/TPMI values may be predefined by a specification, or may be notified/configured/activated by RRC signaling/MAC CE.

Note that it is studied that dynamic indication of/switching between single PUSCH transmission/PUSCH repetition transmission using a single TRP (STRP) and PUSCH repetition transmission using multiple TRPs (Multi TRP (MTRP)) is performed by DCI. For the dynamic switch, a specific field defined in Rel. 16 (or earlier versions) and included in DCI may be used, or a specific field defined in Rel. 17 (or later versions) (for example, a field for specifying STRP or MTRP operation) may be used.

“Dynamic switch” in the present disclosure may mean “switch using at least one of higher layer signaling and physical layer signaling.” “Switch” in the present disclosure may be used interchangeably with switching, change, changing, application, indication, configuration, or the like.

### Timing Advance Group

Using a plurality of TRPs also leads to a case where distances between the UE and the respective TRPs are different from each other. The plurality of TRPs may be included in the same cell (for example, a serving cell). Alternatively, a certain TRP of the plurality of TRPs may correspond to a serving cell, and another TRP may correspond to a non-serving cell. In this case, it is also assumed that distances between the respective TRPs and the UE are different from each other.

In existing systems, a transmission timing of a UL (Uplink) channel and/or a UL signal (UL channel/signal) is adjusted by a timing advance (TA). A reception timing of UL channels/signals from different UEs is adjusted by a radio base station (also referred to as a TRP (Transmission and Reception Point), a gNB (gNodeB), or the like).

The UE may control a timing of UL transmission by applying a timing advance (multiple timing advances) for each preconfigured timing advance group (TAG).

When applying the multiple timing advances, the UE supports a timing advance group (TAG) classified by a transmission timing. The UE may control a UL transmission timing in each TAG by assuming that the same TA offset (or TA value) is applied for each TAG. In other words, TA offsets may each be independently configured for each TAG.

When applying the multiple timing advances, the UE independently adjusts a transmission timing in a cell belonging to each TAG, thereby allowing a timing of uplink signal reception from the UE to be adjusted in the radio base station even when a plurality of cells are used.

The TAG (for example, serving cells belonging to the same TAG) may be configured by a higher layer parameter. The same timing advance value may be applied to serving cells belonging to the same TAG. A timing advance group including an SpCell for a MAC entity may be referred to as a primary timing advance group (PTAG), and a TAG other than the group may be referred to as a secondary timing advance group (STAG).

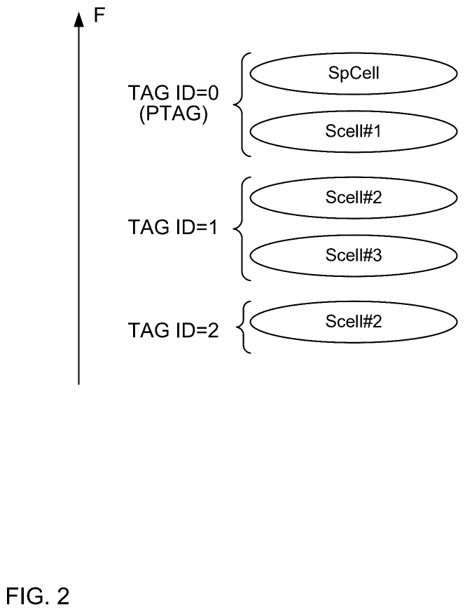

In an existing system (for example, Rel-16 NR), configuration of up to four TAGs is supported for each cell group (for example, MCG/SCG) (see FIG. 2). FIG. 2 shows a case where three TAGs are configured for a cell group including an SpCell and SCells #1 to #4. FIG. 2 shows a case where the SpCell and SCell #1 belong to a first TAG (PTAG or TAG #0), SCell #2 and SCell #3 belong to a second TAG (TAG #1), and SCell #4 belongs to a third TAG (TAG #2).

A timing advance command (TA command) may be notified to the UE by using a MAC control element (for example, a MAC CE). The TA command is a command indicating a transmission timing value of an uplink channel, and is included in the MAC control element. The TA command is signaled at a MAC layer from the radio base station to the UE. The UE controls a given timer (for example, a TA timer), based on reception of the TA command.

The MAC CE for the timing advance command may include a field for a timing advance group index (for example, a TAG ID) and a field for a timing advance command.

On the other hand, in future radio communication systems, it is assumed that different TAGS (or TAG-IDs) are configured for one or more TRPs corresponding to a certain cell (or CC).

Alternatively, it is also assumed that different TRPs corresponding to a certain cell share a common TAG.
Alternatively, it is also assumed that a MAC CE for TA command is applied to only one TRP or that a MAC CE for TA command is applied to a plurality of TRPs.

Alternatively, it is also assumed that in inter-cell mobility, UL transmission is controlled, based on a timing advance, for a serving cell (or a TRP of the serving cell) and a non-serving cell (or a TRP of the non-serving cell). The TRP of the serving cell may be referred to as a primary TRP (for example, a pTRP). The TRP of the non-serving cell may be referred to as an additional TRP (aTRP).

In existing systems (for example, Rel-16 NR), a TAG ID is configured/defined for each cell (or CC) included in a cell group/in units of a cell.

However, when one or more TRPs/PCIs are supported/configured for the cell, how to control application of the timing advance is an issue. For example, it is also assumed that in MIMO in Rel. 18 (or later versions), two timing advances (TAs) for two TRPs are supported in multi-TRP operation using multi-DCI, but progress has not been made on a study of how to judge a TA to be applied to certain UL transmission. Unless this is made clear, an increase in communication throughput and improvement of communication quality may be suppressed.

Thus, the inventors of the present invention came up with the idea of a method for appropriately determining a TA for UL transmission, from among a plurality of TAs (for example, TAs corresponding to separate TRPs).

Embodiments according to the present disclosure will be described in detail with reference to the drawings as follows. The radio communication methods according to respective embodiments may each be employed individually, or may be employed in combination.

In the present disclosure, “A/B” and “at least one of A and B” may be used interchangeably.

In the present disclosure, activate, deactivate, indicate, select, configure, update, determine, and the like may be used interchangeably.

In the present disclosure, RRC, an RRC parameter, an RRC message, RRC signaling, a higher layer parameter, an information element (IE), and a configuration may be used interchangeably. In the present disclosure, a MAC CE, an update command, and an activation/deactivation command may be used interchangeably. In the present disclosure, “support,” “control,” “controllable,” “operate,” and “operable” may be used interchangeably.

In the present disclosure, a field, a parameter, an information element (IE), and the like may be used interchangeably.

In the present disclosure, a panel, a UE panel, a panel group, a beam, a beam group, a precoder, an Uplink (UL) transmission entity, a transmission/reception point (TRP), a base station, spatial relation information (SRI), a spatial relation, an SRS resource indicator (SRI), a control resource set (CORESET), a Physical Downlink Shared Channel (PDSCH), a codeword (CW), a transport block (TB), a reference signal (RS), an antenna, an antenna element, a layer, transmission, a port, an antenna port (for example, a demodulation reference signal (DMRS) port), an antenna port group (for example, a DMRS port group), a group (for example, a spatial relation group, a code division multiplexing (CDM) group, a reference signal group, a CORESET group, a Physical Uplink Control Channel (PUCCH) group, a PUCCH resource group), a resource (for example, a reference signal resource, an SRS resource), a resource set (for example, a reference signal resource set), a CORESET pool, a downlink Transmission Configuration Indication state (TCI state) (DL TCI state), an uplink TCI state (UL TCI state), a unified TCI state, a common TCI state, quasi-co-location (QCL), QCL assumption, and the like may be used interchangeably.

A spatial relation information Identifier (ID) (TCI state ID) and spatial relation information (TCI state) may be used interchangeably. “Spatial relation information” may be used interchangeably as “a set of spatial relation information”, “one or a plurality of pieces of spatial relation information”, and the like. The TCI state and the TCI may be used interchangeably.

In the present disclosure, an index, an ID, an indicator, and a resource ID may be used interchangeably. In the present disclosure, a sequence, a list, a set, a group, a cluster, a subset, and the like may be used interchangeably.

In the present disclosure, a TRP index, a CORESET pool index (CORESETPoolIndex), a pool index, a group index, and the like may be used interchangeably.

In the present disclosure, a single PDCCH (DCI) may be referred to as a PDCCH (DCI) of a first scheduling type (for example, scheduling type A (or type 1)). Multi-PDCCH (DCI) may be referred to as a PDCCH (DCI) of a second scheduling type (for example, scheduling type B (or type 2)).

In the present disclosure, for the single DCI, an i-th TRP (TRP #i) may mean an i-th TCI state, an i-th CDM group, or the like (i is an integer). For the multi-DCI, an i-th TRP (TRP #i) may mean a CORESET corresponding to CORESET pool index=i, an i-th TCI state, an i-th CDM group, or the like (i is an integer).

In the present disclosure, multi-TRP (MTRP, M-TRP), a multi-TRP system, multi-TRP transmission, and multi-PDSCH may be used interchangeably.

In the present disclosure, single DCI (sDCI), a single PDCCH, a multi-TRP system based on single DCI, sDCI-based MTRP, a plurality of PUSCHs (corresponding to different SRIs) being scheduled by one piece of DCI, sDCI-based MTRP transmission, and two TCI states in at least one TCI codepoint being activated may be used interchangeably.

In the present disclosure, multi-DCI (mDCI), multi-PDCCH, a multi-TRP system based on multi-DCI, mDCI-based MTRP, mDCI-based MTRP transmission, multi-DCI being used for MTRP, a plurality of PUSCHs (corresponding to different SRIs) being scheduled by two pieces of DCI, and two CORESET pool indices or CORESET pool index =1 (or a value being one or greater) being configured may be used interchangeably.

Repetitions of the present disclosure may be used interchangeably as MTRP-based repetitions, repetitions of Rel. 17, repetitions applying different spatial relations, repetition PUSCHs, repetition PUCCHs, repetition transmission, and the like. Repetition transmission in the following embodiments may correspond to at least one of repetition transmission type A, repetition transmission type B, and another repetition transmission type.

Note that, in repetition PUSCHs, the same codeword/transport block may be transmitted on each PUSCH (each repetition). The repetition PUSCHs may be used interchangeably with a plurality of PUSCHs having the same contents (for example, data/codeword/transport block).

In the present disclosure, a first TRP and a second TRP may be used interchangeably with a first PUSCH and a second PUSCH, a first PUSCH transmission occasion and a second PUSCH transmission occasion, first SRI and second SRI, and the like.

MTRP PUSCH repetitions in the present disclosure may be used interchangeably with two PUCCH repetitions to two TRPs, two PUSCH repetitions using two SRIs, two PUSCH repetitions using a set of two power control parameters (which are mentioned below), or the like.

In the present disclosure, repetition of an STRP PUSCH may mean repetition transmission of a plurality of PUSCHs transmitted by using one (same) SRI/power control parameter set/beam/precoder. Note that single transmission may mean PUSCH transmission transmitted by using one SRI/power control parameter set/beam/precoder.

Note that PUSCH repetition/PUSCH transmission to TRP 1 (first TRP) may mean PUSCH repetition/PUSCH transmission using a first SRI (or SRI field)/first power control parameter set.

PUSCH repetition/PUSCH transmission to TRP 2 (second TRP) may mean PUSCH repetition/PUSCH transmission using a second SRI (or SRI field)/second power control parameter set.

Note that, in the present disclosure, a power control parameter may be at least one of P_{CMAX,f,c}, Maximum Power Reduction (MPR), P-MPR, additional maximum power reduction (Additional MPR) (A-MPR)), ΔTc, P₀, alpha, a pathloss reference signal (PL-RS), and a closed-loop index (l). A power control parameter set may mean a set including one or more power control parameters.

In the following embodiments, PUSCH repetition transmission using a plurality of TRPs may be used interchangeably with an M-TRP PUSCH, MTRP PUSCH repetition, PUSCH transmission using a plurality of TRPs, PUSCH repetition transmission for a plurality of TRPs, a PUSCH over a plurality of TRPs, repetition PUSCHs over a plurality of TRPs, repetition PUSCHs simply, repetition transmission, a plurality of PUSCH transmissions, PUSCH transmission using a plurality of SRIs, an M-TRP PUSCH, or the like.

PUSCH transmission using a single TRP may be referred to as an S-TRP PUSCH, STRP PUSCH repetition, PUSCH transmission using a single TRP, PUSCH repetition transmission for a single TRP, a PUSCH over a single TRP, repetition PUSCHs over a single TRP, single PUSCH transmission for a single TRP, single PUSCH transmission simply, PUSCH transmission in a single TRP, PUSCH transmission using a single SRI, or the like.

In the following embodiments, a “plurality of” and “two” may be used interchangeably. A “TAG” and a “TAG ID” may be used interchangeably. A “cell,” a “CC,” and a “carrier” may be used interchangeably.

The following description may be employed in inter-cell mobility (for example, L1/L2 inter cell mobility), or may be employed in communication control other than the inter-cell mobility.

In the following embodiments, a TRP ID may be used interchangeably with a CORESET pool index (CORESETPool Index), or may be used interchangeably with a new TA-related ID. The new TA-related ID with a different value may indicate application of a different TA to UL transmission.

### Radio Communication Method

### First Embodiment

A first embodiment relates to determination of a TA to be applied to (used for) UL transmission.

In the first embodiment, when a certain TRP ID is associated with a certain channel/signal, a UE may determine, based on the TRP ID, a TA to be applied to transmission of the channel/signal, and may adjust (control, determine) an uplink timing for the transmission of the channel/signal.

Note that a TA corresponding to a first TRP ID may be controlled/managed separately from a TA corresponding to a second TRP ID. A TA command for the first TRP ID may not affect the TA corresponding to the second TRP ID, or may affect the TA in common.

A case where the above certain channel/signal is a PUSCH scheduled by a DCI format (which may be referred to as a dynamic PUSCH, a dynamic scheduling PUSCH, or the like), a case where the above certain channel/signal is PUSCH transmission without a dynamic grant (which may be referred to as a configured grant (CG) PUSCH), a case where the above certain channel/signal is a PUCCH, and a case where the above certain channel/signal is an SRS will each be described below.

### Dynamic PUSCH

A TRP ID associated with the dynamic PUSCH may be at least one of the following:
Being associated with PDCCH/CORESET for transmitting DCI (scheduling DCI) for scheduling above dynamic PUSCH
Being specified in scheduling DCI
Being associated with TCI state specified for above dynamic PUSCH
Being associated with SRI specified for above dynamic PUSCH
Being associated with CB/NCB SRS resource (or CB/NCB SRS resource set) specified for above dynamic PUSCH

Note that the PDCCH/CORESET for transmitting the scheduling DCI may be referred to as a scheduling PDCCH/CORESET.

The association (correspondence) between the above respective elements and the TRP ID may be predefined in a specification, or may be configured/activated/specified by RRC/MAC CE/DCI.

The above PDCCH/CORESET/TCI state/SRI/SRS resource/SRS resource set may be configured/activated/specified by RRC/MAC CE/DCI.

Note that when a plurality of TCI states/SRIs/SRS resources/SRS resource sets are specified for the dynamic PUSCH, a TRP ID associated with the dynamic PUSCH may be associated with at least one of the above plurality of TCI states/SRIs/SRS resources/SRS resource sets. For example, when two TCI states are specified for the dynamic PUSCH, a TRP ID associated with the dynamic PUSCH may be associated with at least one of a first TCI state and a second TCI state of the two TCI states.

### Configured Grant PUSCH

A TRP ID associated with the configured grant PUSCH may be at least one of the following:
Being associated with configured grant configuration
Being associated with PDCCH/CORESET for transmitting activation DCI when above configured grant PUSCH is type 2 configured grant PUSCH
Being specified in activation DCI
Being associated with TCI state specified for above configured grant PUSCH
Being associated with SRI specified for above configured grant PUSCH
Being associated with CB/NCB SRS resource (or CB/NCB SRS resource set) specified for above configured grant PUSCH
Being predefined/fixed

The association (correspondence) between the above respective elements and the TRP ID may be predefined in a specification, or may be configured/activated/specified by RRC/MAC CE/DCI.

For example, the TRP ID associated with the configured grant configuration may be configured in configured grant configuration (RRC information element “ConfiguredGrantConfig”), or may be associated with a configured grant configuration index (RRC parameter “configuredGrantConfigIndex”).

The above configured grant configuration/PDCCH/CORESET/TCI state/SRI/SRS resource/SRS resource set may be configured/activated/specified by RRC/MAC CE/DCI.

Note that when a plurality of TCI states/SRIs/SRS resources/SRS resource sets are specified for the configured grant PUSCH, a TRP ID associated with the configured grant PUSCH may be associated with at least one of the above plurality of TCI states/SRIs/SRS resources/SRS resource sets.

The above predefined/fixed TRP ID may be a specific value (for example, 0). In this case, it may be assumed that a TA per TRP is not supported for the configured grant PUSCH.

### PUCCH

A TRP ID associated with the PUCCH may be at least one of the following:
Being associated with PDCCH/CORESET/search space set for transmitting DCI when this DCI indicates/triggers PUCCH resource/PUCCH transmission
Being specified in above DCI
Being associated with PUCCH resource/PUCCH resource group configured/activated by RRC/MAC CE
Being associated with TCI state specified for above PUCCH
Being associated with UCI transmitted on above PUCCH
Being predefined/fixed

The association (correspondence) between the above respective elements and the TRP ID may be predefined in a specification, or may be configured/activated/specified by RRC/MAC CE/DCI.

The above PDCCH/CORESET/search space set/TCI state may be configured/activated/specified by RRC/MAC CE/DCI.

For the above PUCCH resource/PUCCH resource group configured/activated by the RRC/MAC CE, a plurality of respective configured/activated PUCCH resources/PUCCH resource groups may be associated with different TRPs. For example, two respective PUCCH resource groups may be associated with different TRPs, and different TAs may be applied to the PUCCH resource groups.

Note that when a plurality of TCI states are specified for the PUCCH, a TRP ID associated with the PUCCH may be associated with at least one of the above plurality of TCI states.

“Being associated with UCI” described above may be used interchangeably with being associated with a type of UCI (which may be referred to as a UCI type), or may be used interchangeably with being associated with a value of UCI. For example, a TRP ID associated with the PUCCH may be associated with a HARQ-ACK transmitted on the PUCCH, may be associated with an SR transmitted on the PUCCH, or may be associated with a CSI report transmitted on the PUCCH.

When the TRP ID is associated with the HARQ-ACK, the TRP ID may be associated with a resource for the HARQ-ACK, may be associated with a PDSCH corresponding to the HARQ-ACK, may be associated with a codebook (for example, codebook type, codebook size) for the HARQ-ACK, may be associated with a feedback mode (for example, joint or separate) for the HARQ-ACK, or may be associated with a value of the HARQ-ACK.

When the TRP ID is associated with the SR, the TRP ID may be associated with a resource for the SR, may be associated with a logical channel/logical channel group corresponding to the SR (or priority related to these), or may be associated with a value of the SR.

When the TRP ID is associated with the CSI report, the TRP ID may be associated with a resource for the CSI report, may be associated with time domain behavior of the CSI report (for example, periodic, semi-persistent, aperiodic), or may be associated with CSI included in the CSI report (for example, CSI part ½, PMI, RI, L1-RSRP, L1-SINR, and the like).

The above predefined/fixed TRP ID may be a specific value (for example, 0). In this case, it may be assumed that a TA per TRP is not supported for the PUCCH.

Note that the association (correspondence) between the PUCCH and the TRP ID may vary for each PUCCH format. The association (correspondence) between the PUCCH and the TRP ID may vary for PUCCHs for different UCI types (in other words, the association between the PUCCH and the TRP ID may vary between a PUCCH for a first UCI type and a PUCCH for a second UCI type).

### SRS

A TRP ID associated with the SRS may be at least one of the following:
Being associated with PDCCH/CORESET/search space set for transmitting DCI when this DCI indicates/triggers SRS resource/SRS transmission (in other words, in case of A-SRS)
Being specified in above DCI
Being associated with SRS resource/SRS resource set configured/activated by RRC/MAC CE
Being associated with TCI state specified for above SRS
Being predefined/fixed

The association (correspondence) between the above respective elements and the TRP ID may be predefined in a specification, or may be configured/activated/specified by RRC/MAC CE/DCI.

The above PDCCH/CORESET/search space set/TCI state may be configured/activated/specified by RRC/MAC CE/DCI.

For the above SRS resource/SRS resource set configured/activated by the RRC/MAC CE, a plurality of respective configured/activated SRS resources/SRS resource sets may be associated with different TRPs. For example, two respective SRS resource sets may be associated with different TRPs, and different TAs may be applied to the SRS resource sets.

For a codebook/non-codebook SRS, when two SRS resource sets are configured for two TRPs, a first SRS resource set (for example, an SRS resource set with a lower ID) and a second SRS resource set (for example, an SRS resource set with a higher ID) may be associated with a first TRP ID (for example, TRP ID=0) and a second TRP ID (for example, TRP ID=1), respectively. Note that the mapping of the ID values may be reversed.

Note that when a plurality of TCI states are specified for the SRS, a TRP ID associated with the SRS may be associated with at least one of the above plurality of TCI states.

The above predefined/fixed TRP ID may be a specific value (for example, 0). In this case, it may be assumed that a TA per TRP is not supported for the SRS.

Note that the association (correspondence) between the SRS and the TRP ID may vary for each usage of an SRS resource set corresponding to the SRS. For example, different TRP ID-related correspondences may be used for respective ones (or some) of codebook, non-codebook, beam management, antenna switching, and positioning usages.

The association (correspondence) between the SRS and the TRP ID may vary for each time domain behavior of an SRS resource set corresponding to the SRS (for example, periodic, semi-persistent, aperiodic).

According to the first embodiment described above, the UE can appropriately determine a TA to be applied to (used for) UL transmission.

### Second Embodiment

A second embodiment relates to determination of TAs for various UL transmission schemes. The TA determination described in the first embodiment may be applied to M-DCI M-TRP PUSCH repetition or another UL transmission scheme.

### Application to S-DCI M-TRP PUSCH Repetition

For Rel-17 NR, S-DCI M-TRP PUSCH repetition is under study.

Here, the S-DCI M-TRP PUSCH repetition (or S-DCI M-TRP PUSCH repetition being enabled) may mean that at least one of the following is satisfied:
PUSCH repetition type A or B is configured.
The number of repetitions greater than 1 is configured/specified.
Two SRS resource sets (for example, for certain usage (codebook/non-codebook)) are configured.
DCI includes two SRI fields (or DCI specifies two TPMIs).
Two power control parameter sets are configured.
Two TCI states (spatial relations) are specified.

The above first embodiment may be employed in the S-DCI M-TRP PUSCH repetition. Two TAs may be used for PUSCH repetition for two TRPs. PUSCH repetition for different TRPs may mean PUSCH repetition associated with different SRS resource sets/SRIs/TPMIs/spatial relations/power control parameter sets/TCI states.

For example, the i-th TA (for example, i=1, 2) may be used for PUSCH repetition associated with an i-th TRP, an i-th SRS resource set (SRS resource set with the i-th lowest/highest ID), an i-th SRI (SRI field), an i-th TPMI (TPMI field), an i-th power control parameter set, or an i-th TCI state.

### Application to M-TRP PUCCH Repetition

For Rel-17 NR, M-TRP PUCCH repetition is under study.

Here, the M-TRP PUCCH repetition (or M-TRP PUCCH repetition being enabled) may mean that at least one of the following is satisfied:
The number of repetitions greater than 1 is configured/specified.
Two TCI states (spatial relations) are configured/activated/indicated for a PUCCH resource.
Two power control parameter sets are configured/activated/indicated for a PUCCH resource.

The above first embodiment may be employed in the M-TRP PUCCH repetition. Two TAs may be used for PUCCH repetition for two TRPs. PUCCH repetition for different TRPs may mean PUCCH repetition associated with different spatial relations/power control parameter sets/TCI states.

For example, the i-th TA (for example, i=1, 2) may be used for PUCCH repetition associated with an i-th TRP, an i-th TCI state, an i-th power control parameter set, or an i-th TCI state.

### TA Gap

A (length of) gap may be defined for transmissions to which different TAs are applied. The gap may indicate time required for switching in which a UE switches from application of a certain TA to application of another TA. This (length of) gap may be referred to as a TA switching gap, a TA gap, or the like. The TA gap may be zero symbol or one or more symbols, and may be represented in a certain unit (for example, u sec). The TA gap may be predefined in a specification, may be configured by higher layer signaling, or may be determined based on a UE capability.

The TA gap may be the same value for all the TA switches, or different values may be used for some TA switches. For example, switching from a first TA value to a second TA value (less than or greater than the first TA value) may be a TA gap smaller/larger than switching from the second TA value to the first TA value.

For the M-DCI M-TRP PUSCH repetition, the UE may not expect that a PUSCH/PUCCH is transmitted in the TA gap (or a PUSCH/PUCCH in the TA gap is scheduled).

For the S-DCI M-TRP PUSCH repetition, the UE may puncture or postpone (or delay) a PUSCH/PUCCH in the TA gap. In other words, when a time period greater than or equal to the TA gap is absent between a first PUSCH/PUCCH repetition and a second PUSCH/PUCCH repetition, the UE may puncture (may not transmit) part or all of the second PUSCH/PUCCH repetition, or may postpone a start of transmission of the second PUSCH/PUCCH repetition (for example, start transmission of the second PUSCH/PUCCH repetition at a timing/slot at which a time period from an end of the first PUSCH/PUCCH repetition greater than or equal to the TA gap is present).

When puncturing part of the second PUSCH/PUCCH repetition, the UE may puncture the second PUSCH/PUCCH repetition before a timing at which the TA gap elapses from an end of the first PUSCH/PUCCH repetition, and may transmit the second PUSCH/PUCCH after the timing.

When postponing the second PUSCH/PUCCH repetition, the UE may puncture the second PUSCH/PUCCH repetition or at least one of the subsequent (third, fourth, . . . ) PUSCH/PUCCH repetitions if a start or end timing of the postponed second PUSCH/PUCCH repetition is separated from a start or end timing of the original (scheduled) second PUSCH/PUCCH repetition by certain time or more.

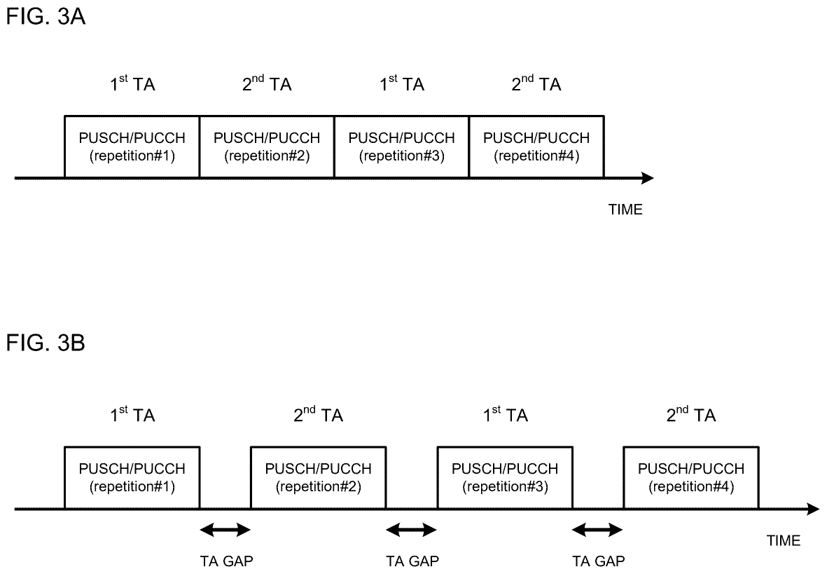

FIGS. 3A and 3B are diagrams to show examples of the postponement based on the TA gap in the M-TRP PUSCH/PUCCH repetition.

In the present example, as shown in FIG. 3A, the UE transmits PUSCHs/PUCCHs (repetitions #1 to #4) with the number of repetitions of 4 while switching TAs. Repetitions #1 and #3 and repetitions #2 and #4 correspond to a first TA and a second TA, respectively. FIG. 3A corresponds to a case where TA gap=0.

FIG. 3B corresponds to a case where TA gap>0. In FIG. 3B, starts of transmissions of repetitions #2, #3, and #4 are each postponed such that each of the transmissions is started with a TA gap from an end of the last repetition.

### Application to Multi-Panel Simultaneous PUSCH Transmission

For Rel-18 NR, multi-panel simultaneous PUSCH transmission is under study.

Here, the multi-panel simultaneous PUSCH transmission (or multi-panel simultaneous PUSCH transmission being enabled) may mean that at least one of the following is satisfied:
1 CW/TB is transmitted from both of panels #1 and #2 by using a PUSCH with L layers (L is an arbitrary integer, for example, L=4, 8) (which may be referred to as coherent multi-panel transmission).
1 CW/TB is transmitted from panel #1 by using the PUSCH with K layers (K<L) from among the PUSCH with L layers, and the 1 CW/TB is transmitted from panel #2 by using the PUSCH with L-K layers from among the PUSCH with L layers (which may be referred to as non-coherent multi-panel transmission of 1 CW/TB).
1 CW/TB (first CW/TB) is transmitted from panel #1 by using the PUSCH with K layers (K<L) from among the PUSCH with L layers, and another 1 CW/TB (second CW/TB) is transmitted from panel #2 by using the PUSCH with L-K layers from among the PUSCH with L layers (which may be referred to as non-coherent multi-panel transmission of 2 CWs/TBs).
In the same time frequency resource, one TB is repetitively transmitted twice by using different beams (which may be referred to as scheme A, SFN repetition, or the like).
In different frequency resources (for example, different PRBs), one TB is repetitively transmitted twice by using different beams (which may be referred to as scheme B, FDM repetition, or the like).
In different frequency resources (for example, different PRBs), one TB is transmitted by using different beams (which may be referred to as scheme B1, FDM transmission, or the like).
One TB is transmitted in one PUSCH, where different layers of the PUSCH are transmitted by using different beams (which may be referred to as scheme C, scheme C1, multiplexing, or the like).
Two TBs are transmitted in one PUSCH, where different TBs are transmitted by using different beams (which may be referred to as scheme C, scheme C2, multiplexing, or the like).

The above first embodiment may be employed in the multi-panel simultaneous PUSCH transmission. Two TAs may be used for PUSCH transmission for two TRPs/with two panels. PUSCH transmission for different TRPs/with different panels may mean PUSCH transmission associated with different SRS resource sets/SRIs/TPMIs/spatial relations/power control parameter sets/TCI states/panels/layers/layer groups/CWs.

For example, the i-th TA (for example, i=1, 2) may be used for PUSCH transmission associated with an i-th TRP, an i-th SRS resource set (SRS resource set with the i-th lowest/highest ID), an i-th SRI (SRI field), an i-th TPMI (TPMI field), an i-th power control parameter set, an i-th TCI state, an i-th panel, an i-th layer, an i-th layer group, or an i-th CW.

### Application to Multi-panel Simultaneous PUCCH Transmission

For Rel-18 NR, multi-panel simultaneous PUCCH transmission is under study.

Here, the multi-panel simultaneous PUCCH transmission (or multi-panel simultaneous PUCCH transmission being enabled) may mean that at least one of the following is satisfied:
In the same time frequency resource, one PUCCH (piece of UCI) is repetitively transmitted twice by using different beams (which may be referred to as scheme 1, SFN repetition, or the like).
In different frequency resources (for example, different PRBs), one PUCCH (UCI) is repetitively transmitted twice by using different beams (which may be referred to as scheme 2, FDM repetition, or the like).
In different frequency resources (for example, different PRBs), one PUCCH (UCI) is transmitted by using different beams (which may be referred to as scheme 2-1, FDM transmission, or the like).
In time resources overlapping each other, two PUCCHs (pieces of UCI) are transmitted by using different beams (which may be referred to as scheme 3, multiplexing, or the like).

The above first embodiment may be employed in the multi-panel simultaneous PUCCH transmission. Two TAs may be used for PUCCH transmission for two TRPs/with two panels. PUCCH transmission for different TRPs/with different panels may mean PUCCH transmission associated with different spatial relations/power control parameter sets/TCI states/panels/layers/layer groups.

For example, the i-th TA (for example, i=1, 2) may be used for PUCCH transmission associated with an i-th TRP, an i-th TCI state, an i-th power control parameter set, an i-th TCI state, an i-th panel, an i-th layer, or an i-th layer group.

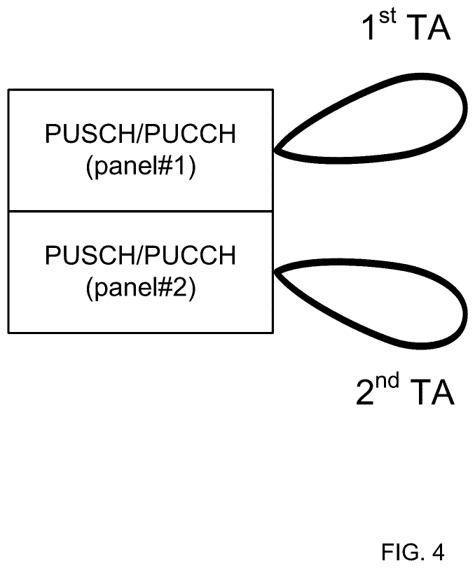

FIG. 4 is a diagram to show an example of application of TAS to the multi-panel simultaneous PUSCH/PUCCH transmission. In the present example, the UE applies, to a PUSCH/PUCCH, different TAs from different panels, and transmits the PUSCH/PUCCH by using different beams.

According to the second embodiment described above, the UE can appropriately determine a TA to be applied to (used for) UL transmission in various transmission schemes.

### Supplement

In the present disclosure, when being configured with an RRC parameter for enabling TRP-specific TA adjustment for UL transmission (for example, PUSCH, SRS, PUCCH), the UE may perform control based on a TRP-specific TA/TAG for the UL transmission.

In the present disclosure, a “panel” may be used interchangeably with a UE capability value, a set of UE capability values, or the like. In this case, transmission using the panel may be used interchangeably with transmission based on a UE capability value (set).

Note that at least one of the above embodiments may be employed only in the UE that has reported a specific UE capability or supports the specific UE capability.

The specific UE capability may indicate at least one of the following:
Support of processing/operation/control/information related to at least one of above embodiments
Support of different TAs for two TRPs of serving cell
Support of different TAs for two TRPs for PUSCH
Support of different TAs for two TRPs for PUCCH
Support of different TAs for two TRPs for SRS
Maximum number of (different) TAs/TAGs supported over one or all serving cells
Support of different TAs for M-DCI M-TRP
Support of different TAs for S-DCI M-TRP

The above specific UE capability may be a capability applied over all the frequencies (in common, regardless of a frequency), may be a capability for each frequency (for example, cell, band, BWP), may be a capability for each frequency range (for example, FR1, FR2, FR3, FR4, FR5, FR2-1, FR2-2), or may be a capability for each subcarrier spacing.

The above specific UE capability may be a capability applied over all the duplex schemes (in common, regardless of a duplex scheme), or may be a capability for each duplex scheme (for example, time division duplex (TDD), frequency division duplex (FDD)).

At least one of the above embodiments may be employed in a case where the UE is configured with specific information associated with the above embodiments, by higher layer signaling. For example, the specific information may be configuration information for a PUSCH/PUCCH using a plurality of TAs, an RRC parameter for enabling TRP-specific TA adjustment, an arbitrary RRC parameter for specific release (for example, Rel. 18), or the like.

When not supporting at least one of the above specific UE capabilities or not being configured with the above specific information, the UE may apply operation of Rel. 15/16, for example.

### Radio Communication System

Hereinafter, a structure of a radio communication system according to one embodiment of the present disclosure will be described. In this radio communication system, the radio communication method according to each embodiment of the present disclosure described above may be used alone or may be used in combination for communication.

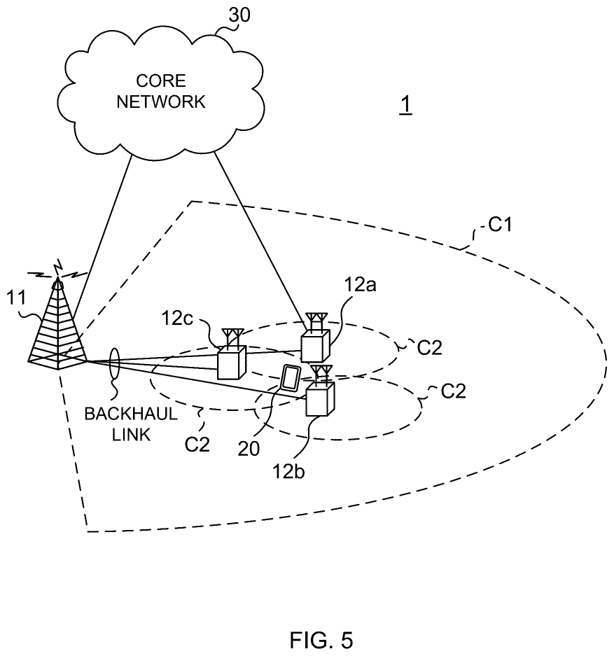

FIG. 5 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHZ), and FR2 may be a frequency band which is higher than 24 GHZ (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are transmitted on the PDSCH. User data, higher layer control information and so on may be transmitted on the PUSCH. The Master Information Blocks (MIBs) may be transmitted on the PBCH.

Lower layer control information may be transmitted on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be used interchangeably with “DL data,” and the PUSCH may be used interchangeably with “UL data.”

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be used interchangeably.

Uplink control information (UCI) including at least one of channel state information (CSI), transmission confirmation information (for example, which may be referred to as Hybrid Automatic Repeat reQuest ACKnowledgement (HARQ-ACK), ACK/NACK, and so on), and scheduling request (SR) may be transmitted by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be transmitted as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be referred to as a “reference signal.”

In the radio communication system 1, a sounding reference signal (SRS), a demodulation reference signal (DMRS), and so on may be transmitted as an uplink reference signal (UL-RS). Note that DMRS may be referred to as a “user terminal specific reference signal (UE-specific Reference Signal).”

### Base Station

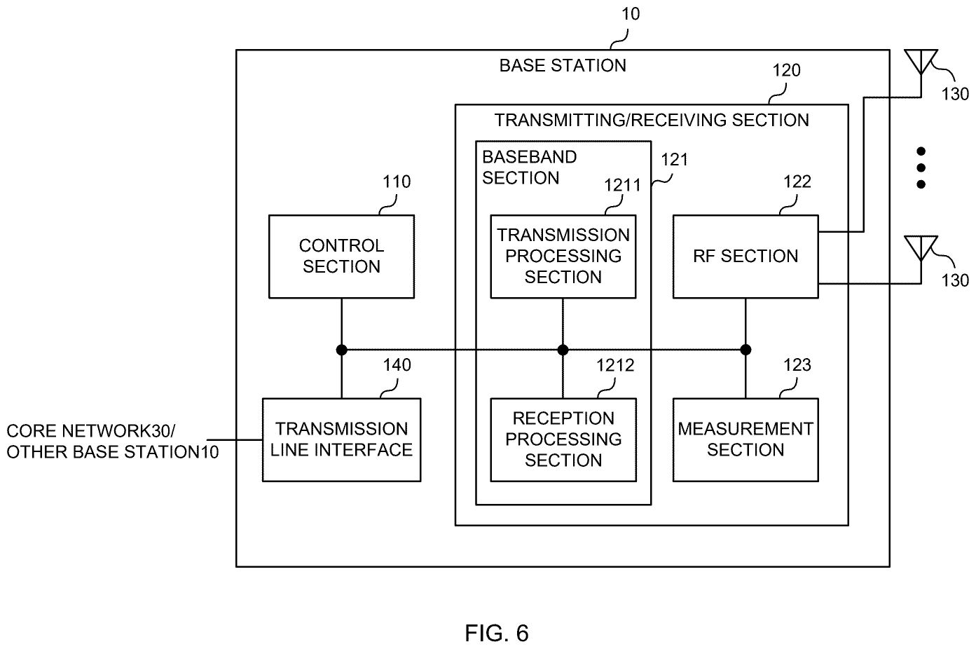

FIG. 6 is a diagram to show an example of a structure of the base station according to one embodiment. The base station 10 includes a control section 110, a transmitting/receiving section 120, transmitting/receiving antennas 130 and a transmission line interface 140. Note that the base station 10 may include one or more control sections 110, one or more transmitting/receiving sections 120, one or more transmitting/receiving antennas 130, and one or more transmission line interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the transmission line interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The transmission line interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the transmission line interface 140.

Note that the transmitting/receiving section 120 may transmit information related to a specific index to the user terminal 20. The transmitting/receiving section 120 may receive an uplink transmission transmitted from the user terminal 20, based on a timing advance judged based on the specific index, from among a plurality of timing advances.

### User Terminal

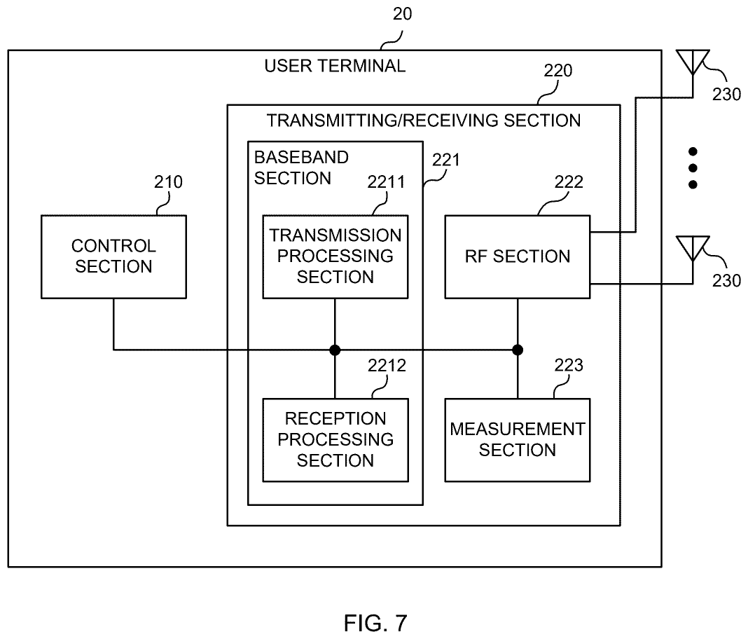

FIG. 7 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a given channel (for example, PUSCH), the DFT processing as the above-described transmission processing to transmit the channel by using a DFT-s-OFDM waveform if transform precoding is enabled, and otherwise, does not need to perform the DFT processing as the above-described transmission processing.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply reception processing such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

Note that the control section 210 may judge, based on a specific index (for example, TRP ID), a timing advance to be applied to certain uplink transmission (for example, PUSCH, PUCCH, SRS), from among a plurality of timing advances (for example, TA for TRP ID #0 and TA for TRP ID #1).

The transmitting/receiving section 220 may perform the uplink transmission, based on the timing advance.

The specific index may be associated with downlink control information (DCI) for scheduling or triggering the uplink transmission.

The specific index may be associated with a Transmission Configuration Indication state (TCI state) specified for the uplink transmission.

The specific index may be associated with a sounding reference signal (SRS) resource or an SRS resource set specified for the uplink transmission.

### Hardware Structure

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

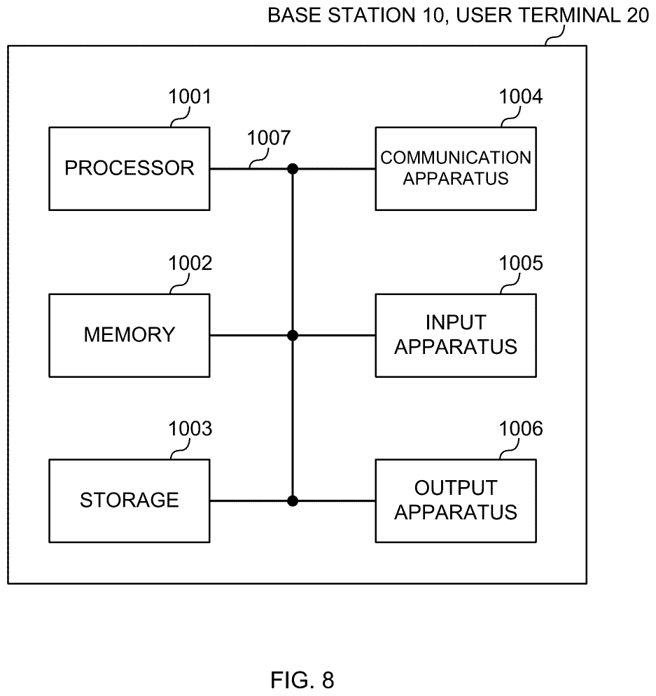

For example, a base station, a user terminal, and so on according to one embodiment of the present disclosure may function as a computer that executes the processes of the radio communication method of the present disclosure. FIG. 8 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be used interchangeably. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing given software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### Variations

Note that the terminology described in the present disclosure and the terminology that is needed to understand the present disclosure may be replaced by other terms that convey the same or similar meanings. For example, a “channel,” a “symbol,” and a “signal” (or signaling) may be used interchangeably. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a given signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be used interchangeably.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIs.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be used interchangeably with a TTI having a time length exceeding 1 ms, and a short TTI (for example, a shortened TTI and so on) may be used interchangeably with a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a given signal/channel outside active BWPs. Note that a “cell,” a “carrier,” and so on in the present disclosure may be used interchangeably with a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to given values, or may be represented in another corresponding information. For example, radio resources may be specified by given indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CEs).

Also, reporting of given information (for example, reporting of “X holds”) does not necessarily have to be reported explicitly, and can be reported implicitly (by, for example, not reporting this given information or reporting another piece of information).

Determinations may be made in values represented by one bit (0 or 1), may be made in Boolean values that represent true or false, or may be made by comparing numerical values (for example, comparison against a given value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be a device mounted on a moving object or a moving object itself, and so on.

The moving object is a movable object with any moving speed, and naturally a case where the moving object is stopped is also included. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, an artificial satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an autonomous car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

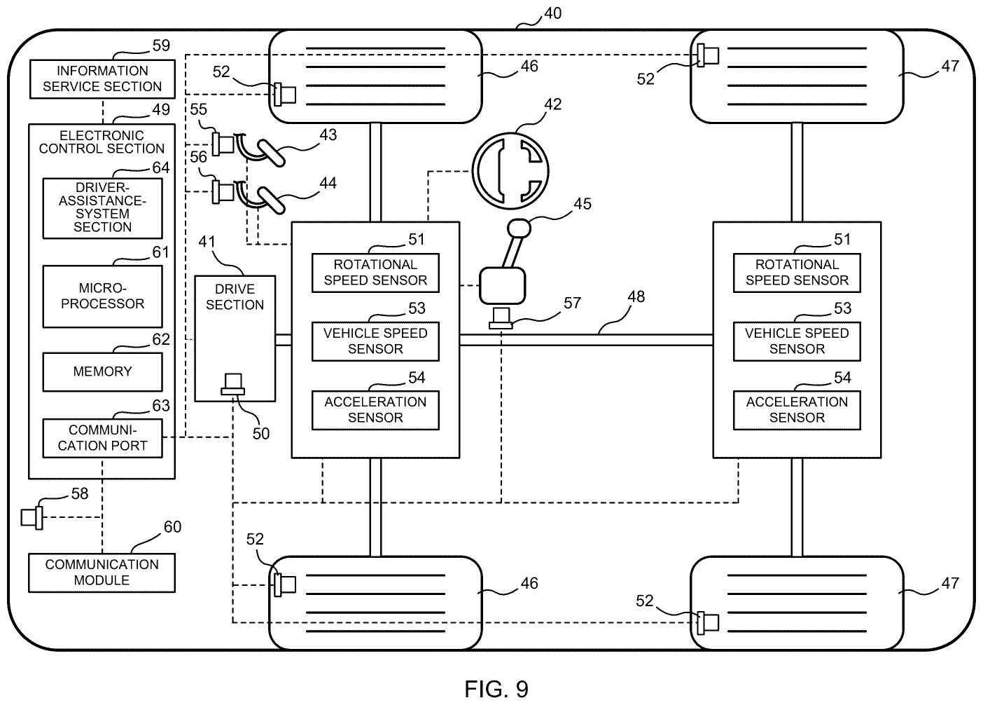

FIG. 9 is a diagram to show an example of a vehicle according to one embodiment. A vehicle 40 includes a drive section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The drive section 41 includes, for example, at least one of an engine, a motor, and a hybrid of an engine and a motor. The steering section 42 at least includes a steering wheel, and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (IO) port) 63. The electronic control section 49 receives, as input, signals from the various sensors 50 to 58 included in the vehicle. The electronic control section 49 may be referred to as an Electronic Control Unit (ECU).

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes various devices for providing (outputting) various pieces of information such as drive information, traffic information, and entertainment information, such as a car navigation system, an audio system, a speaker, a display, a television, and a radio, and one or more ECUs that control these devices. The information service section 59 provides various pieces of information/services (for example, multimedia information/multimedia service) for an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driver-assistance-system section 64 includes various devices for providing functions for preventing an accident and reducing a driver's driving load, such as a millimeter wave radar, Light Detection and Ranging (LiDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor, and one or more ECUS that control these devices. The driver-assistance-system section 64 transmits and receives various pieces of information via the communication module 60, and implements a driving assistance function or an autonomous driving function.

The communication module 60 can communicate with the microprocessor 61 and the constituent elements of the vehicle 40 via the communication port 63. For example, via the communication port 63, the communication module 60 transmits and receives data (information) to and from the drive section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 can be controlled by the microprocessor 61 of the electronic control section 49, and is a communication device that can perform communication with an external apparatus. For example, the communication module 60 performs transmission and reception of various pieces of information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals from the various sensors 50 to 58 described above input to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various pieces of information (traffic information, signal information, inter-vehicle distance information, and the like) transmitted from the external apparatus, and displays the various pieces of information on the information service section 59 included in the vehicle. The information service section 59 may be referred to as an output section that outputs information (for example, outputs information to devices, such as a display and a speaker, based on the PDSCH received by the communication module 60 (or data/information decoded from the PDSCH)).

The communication module 60 stores the various pieces of information received from the external apparatus in the memory 62 that can be used by the microprocessor 61. Based on the pieces of information stored in the memory 62, the microprocessor 61 may perform control of the drive section 41, the steering section 42, the accelerator pedal 43, the brake pedal 44, the shift lever 45, the right and left front wheels 46, the right and left rear wheels 47, the axle 48, the various sensors 50 to 58, and the like included in the vehicle 40.

Furthermore, the base station in the present disclosure may be used interchangeably with a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words such as “uplink” and “downlink” may be used interchangeably with the words corresponding to the terminal-to-terminal communication (for example, “sidelink”). For example, an uplink channel, a downlink channel and so on may be used interchangeably with a sidelink channel.

Likewise, the user terminal in the present disclosure may be used interchangeably with base station. In this case, the base station 10 may have the functions of the user terminal 20 described above.

Actions which have been described in the present disclosure to be performed by a base station may, in some cases, be performed by upper nodes of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG) (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods, next-generation systems that are enhanced, modified, created, or defined based on these, and the like. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be used interchangeably with “assuming,” “expecting,” “considering,” and the like.

“The maximum transmit power” according to the present disclosure may mean a maximum value of the transmit power, may mean the nominal maximum transmit power (the nominal UE maximum transmit power), or may mean the rated maximum transmit power (the rated UE maximum transmit power).

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be used interchangeably with “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B are each different from C.” The terms “separate,” “coupled,” and so on may be interpreted in a similar manner to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1.-6. (canceled)

7. A terminal comprising:
a processor that determines, based on an index of a transmission/reception point (TRP), a timing advance (TA) to be applied to an uplink transmission from among a plurality of TAs; and
a transmitter that performs the uplink transmission, based on the TA.

8. The terminal according to claim 7, wherein when the uplink transmission is a transmission of a physical uplink shared channel (PUSCH), the index of the TRP relates to a control resource set (CORESET).

9. The terminal according to claim 8, wherein the transmission of the PUSCH is a transmission of a PUSCH dynamically scheduled by downlink control information (DCI) or a transmission of a type 2 configured grant PUSCH.

10. The terminal according to claim 7, wherein when the uplink transmission is a transmission of a physical uplink control channel (PUCCH), the index of the TRP relates to a resource of the PUCCH or a resource group of the PUCCH configured by a higher layer parameter.

11. The terminal according to claim 7, wherein when the uplink transmission is a transmission of a sounding reference signal (SRS), the index of the TRP relates to a resource set of the SRS configured by a higher layer parameter.

12. The terminal according to claim 7, wherein the transmitter transmits at least one of UE capability information regarding whether or not to support different TAs for a plurality of TRPs based on single downlink control information (DCI) and UE capability information regarding whether or not to support different TAs for the plurality of TRPs based on multiple DCI.

13. A radio communication method for a terminal, comprising:
determining, based on an index of a transmission/reception point (TRP), a timing advance (TA) to be applied to an uplink transmission from among a plurality of TAs; and
performing the uplink transmission, based on the TA.

14. A base station comprising:
a transmitter that transmits an index of a transmission/reception point (TRP) to a terminal; and
a processor that controls reception of an uplink transmission that is transmitted based on a timing advance determined, from among a plurality of timing advances, based on the index of the TRP.

15. A system comprising a terminal and a base station, wherein
the terminal comprises:
a processor that determines, based on an index of a transmission/reception point (TRP), a timing advance (TA) to be applied to an uplink transmission from among a plurality of TAs; and
a transmitter that performs the uplink transmission, based on the TA, and
the base station comprises:
a transmitter that transmits the index of the TA to the terminal; and
a processor that controls reception of the uplink transmission.
